(19) United States
(12) Patent Application Publication
(10) Pub. No.: US 2013/0073748 A1
(43) Pub. Date: Mar. 21, 2013

(54) INFORMATION COMMUNICATION SYSTEM, CLIENT APPARATUS, AND HOST APPARATUS

(71) Applicants: Akira MASUDA, Tokyo (JP); Takeshi FUJITA, Tokyo (JP); Yasuharu YANAMURA, Kanagawa (JP); Yohei FUJITA, Kanagawa (JP); Tetsuro KUTSUWADA, Kanagawa (JP); Kohichi NISHIDE, Tokyo (JP)

(72) Inventors: Akira MASUDA, Tokyo (JP); Takeshi FUJITA, Tokyo (JP); Yasuharu YANAMURA, Kanagawa (JP); Yohei FUJITA, Kanagawa (JP); Tetsuro KUTSUWADA, Kanagawa (JP); Kohichi NISHIDE, Tokyo (JP)

(73) Assignee: RICOH COMPANY, LTD., Tokyo (JP)

(21) Appl. No.: 13/611,108

(22) Filed: Sep. 12, 2012

(30) Foreign Application Priority Data
Sep. 15, 2011 (JP) 2011-202425

(51) Int. Cl. G06F 3/00; H04R 29/00

(52) U.S. Cl. 710/15

(57) ABSTRACT

An information communication system includes a host apparatus configured to generate and output a connection information sound; a client apparatus configured to gather the connection information sound output by the host apparatus; and a sound analyzing unit configured to analyze the connection information sound and obtain connection information from the connection information sound; wherein the client apparatus includes a communication unit configured to establish communication with the host apparatus based on the connection information obtained by the sound analyzing unit.

### BACKGROUND OF THE INVENTION

1. Field of the Invention

The disclosures herein generally relate to an information communication system, a client apparatus, and a host apparatus.

2. Description of the Related Art

A technique is known for connecting devices such as a printer, a multifunction peripheral (MFP), or a projector to a personal computer (PC) or a tablet terminal of a user via a communication network and using the connected device to output information stored in the PC or tablet terminal. Also, a technique is known for enabling such devices and the PC or the tablet terminal of the user to exchange data with each other via a communication network.

Further, a technique is known for establishing connection with a device by searching from a PC or a tablet terminal one or more devices that are connected to a communication network. In the above technique, a search is made for any device that is connected to the same network and the search result will consist of all devices connected to this network. In this case, when a user wishes to establish connection with a device that is located physically close to the user's current location, the user will be unable to determine based on the search result which device is physically close to his/her current location.

Japanese Patent No. 4074998 discloses a method of searching a communication mate whose location in the real world is clear but whose identification information on the communication medium is unknown, the method involving generating a real world event and searching a communication mate that shares the real world event on a network.

The above method involves generating a real world event by causing physical contact between a first communication apparatus and a second communication apparatus so that the first and second communication apparatuses share a shock wave pattern generated by the physical contact, and having the first communication apparatus search the second communication apparatus that is located right in front of the first communication apparatus. However, in the case of searching for a communication mate on the network by sharing such a shock wave pattern, since the physical distance between the communication apparatuses and their distance on the network are different, it is difficult to determine how far a search should be conducted over the network to detect the communication mate.

Also, a search on the network usually covers only the same sub-network so that a device that is not within the same sub-network will not be subject to the search. For example, a wired device such as a printer and a wireless device such as a tablet terminal belong to different sub-networks so that the wireless device will be unable to detect the wired device.

On the other hand, in a search using a communication protocol for exchanging data over short distances such as Bluetooth (registered trademark), the search involves the use of radio waves so that even remotely located devices such as those located outside a room may be detected. Therefore, such a search method would not be suitable where connection is desired with a device that is located within a predetermined range such as inside a meeting room or a device right in front of a user.

### SUMMARY OF THE INVENTION

It is a general object of at least one embodiment of the present invention to provide an information communication system, a client apparatus, and a host apparatus that can substantially obviate one or more problems caused by the limitations and disadvantages of the related art.

In one embodiment of the present invention, an information communication system includes a host apparatus configured to generate and output a connection information sound; a client apparatus configured to gather the connection information sound output by the host apparatus; and a sound analyzing unit configured to analyze the connection information sound and obtain connection information from the connection information sound; wherein the client apparatus includes a communication unit configured to establish communication with the host apparatus based on the connection information obtained by the sound analyzing unit.

In another embodiment of the present invention, a client apparatus includes a sound gathering unit configured to gather a connection information sound output by a host apparatus; a sound analyzing unit configured to analyze the connection information sound gathered by the sound gathering unit and obtain connection information from the connection information sound; and a communication unit configured to establish communication with the host apparatus based on the connection information obtained by the sound analyzing unit.

In another embodiment of the present invention, a host apparatus includes a sound generating unit configured to generate a connection information sound including connection information; and a sound output control unit configured to output the connection information sound generated by the sound generating unit.

According to an aspect of the present invention, sound having connection information embedded therein may be used to establish connection with a device that is within a predetermined range.

### BRIEF DESCRIPTION OF THE DRAWINGS

Other objects and further features of embodiments will be apparent from the following detailed description when read in conjunction with the accompanying drawings, in which:

FIG. 1 is a diagram schematically showing an information communication system according to a first embodiment of the present invention;

FIG. 2 is a block diagram schematically showing an exemplary configuration of the information communication system according to the first embodiment;

FIG. 3 is a block diagram showing exemplary functional features of the client apparatus and the host apparatus of the information communication system according to the first embodiment;

FIG. 4 is a block diagram showing exemplary hardware components of the client apparatus and the host apparatus according to the first embodiment;

FIG. 5 is a sequence chart showing an exchange between the client apparatus and the host apparatus according to the first embodiment;

FIG. 6 is a sequence chart showing exemplary process steps of the host apparatus according to one aspect of the first embodiment;

FIG. 7 is a sequence chart showing exemplary process steps of the client apparatus according to one aspect of the first embodiment;

FIGS. 8A and 8B are diagrams illustrating an exemplary method of embedding connection information into sound data;

FIG. 9 is a graph illustrating an exemplary method of extracting connection information from sound data;

FIGS. 10A and 10B are flowcharts showing exemplary process steps of the client apparatus and the host apparatus according to another aspect of the first embodiment;

FIG. 11 is a block diagram showing exemplary functional features of a client apparatus and a host apparatus according to a second embodiment of the present invention;

FIG. 12 is a sequence chart showing an exchange between the client apparatus and the host apparatus according to the second embodiment;

FIG. 13 is a sequence chart showing exemplary process steps of the host apparatus according to one aspect of the second embodiment;

FIG. 14 is a sequence chart showing exemplary process steps of the client apparatus according to one aspect of the second embodiment;

FIG. 15 is a flowchart showing exemplary process steps of the client apparatus according to another aspect of the second embodiment;

FIG. 16 is a flowchart showing exemplary process steps of the host apparatus according to another aspect of the second embodiment;

FIGS. 17A and 17B are diagrams illustrating examples of a predetermined cue for prompting the output of the connection information sound; and

FIGS. 18A and 18B are diagrams illustrating modified embodiments of an information communication system according to the present invention.

### DESCRIPTION OF THE PREFERRED EMBODIMENTS

In the following, embodiments of the present invention are described with reference to the accompanying drawings.

An embodiment of the present invention relates to establishing connection between devices within a predetermined range by having a predetermined device output a connection information sound including connection information and having a device that obtains the connection information sound establish connection with the predetermined device via a communication network.

### First Embodiment

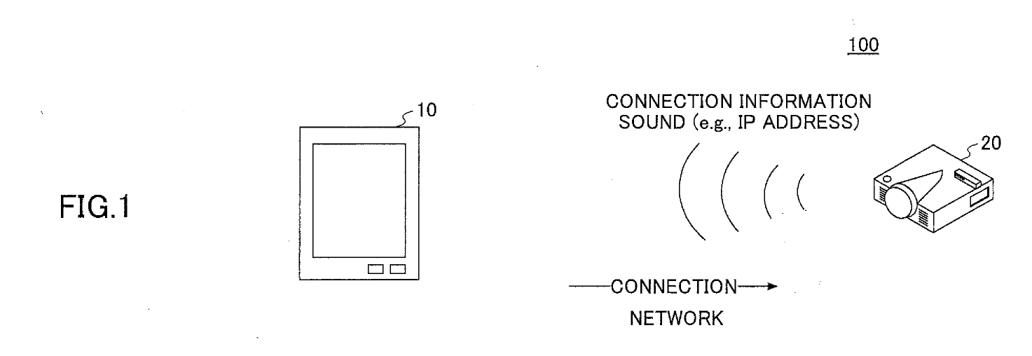

FIG. 1 is a diagram schematically showing an information communication system according to a first embodiment of the present invention. As is shown in FIG. 1, an information communication system 100 according to the first embodiment includes a client apparatus 10 and a host apparatus 20.

The client apparatus 10 may be a portable device such as a tablet terminal, a cell phone, or a smart phone, for example. The host apparatus 20 may be a projector, a MFP, a tablet terminal, or a PC, for example.

In the first embodiment, the client apparatus 10 obtains a connection information sound output by the host apparatus 20 with which connection is to be established, analyzes the connection information sound to obtain connection information included in the connection information sound, and establishes connection with the host apparatus 20 via a communication network. The connection information sound may include an IP (Internet Protocol) address or a MAC (Media Access Control) address as the connection information, for example.

According to an aspect of the present embodiment, even if the client apparatus 10 and the host apparatus 20 belong to different sub-networks, the client apparatus 10 may easily establish connection with the host apparatus 20. For example, when the host apparatus 20 corresponds to a projector located in a meeting room, the client apparatus 10 may establish connection with the host apparatus 20 using the connection information obtained from the connection information sound that is output by the host apparatus 20.

It is noted that in the information communication system 100 of FIG. 1, the client apparatus 10 and the host apparatus 20 may correspond to the same type of device or any combination of different devices. For example, the client apparatus 10 and the host apparatus 20 may correspond to a tablet terminal and a MFP, a tablet terminal and another tablet terminal, a PC and a tablet terminal, or a PC and another PC.

In the case where the client apparatus 10 and the host apparatus 20 correspond to a tablet terminal and a MFP, a user on the go may print data from a tablet terminal using a MFP on the site, for example. In the case where the client apparatus 10 and the host apparatus 20 both correspond to tablet terminals, participants of a meeting may connect their tablet terminals to each other to share materials used in the meeting, for example.

In the case where the client apparatus 10 and the host apparatus 20 correspond to a PC and a terminal tablet, a document stored in a PC may be transferred to a tablet terminal, for example. In the case where the client apparatus 10 and the host apparatus 20 both correspond to personal computers such as laptops, connection may be established between laptops in the same meeting room so that documents may be shared by these laptops, for example.

It is noted that the communication network used in the present embodiment may be a local area network (LAN) or some other network such as Bluetooth (registered trademark).

The connection information sound may include an IP address as connection information for establishing connection to a LAN, for example. In other embodiments, the connection information may be a SSID (Service Set Identifier) and an IP address for establishing an ad hoc connection, or a MAC address and a pass key for establishing connection using Bluetooth (registered trademark). In the case of using an IP address as the connection information, a connection may be established using a general purpose communication device. In the case of using a SSID and an IP address for establishing an ad hoc connection, a network connection may be established without using an access point.

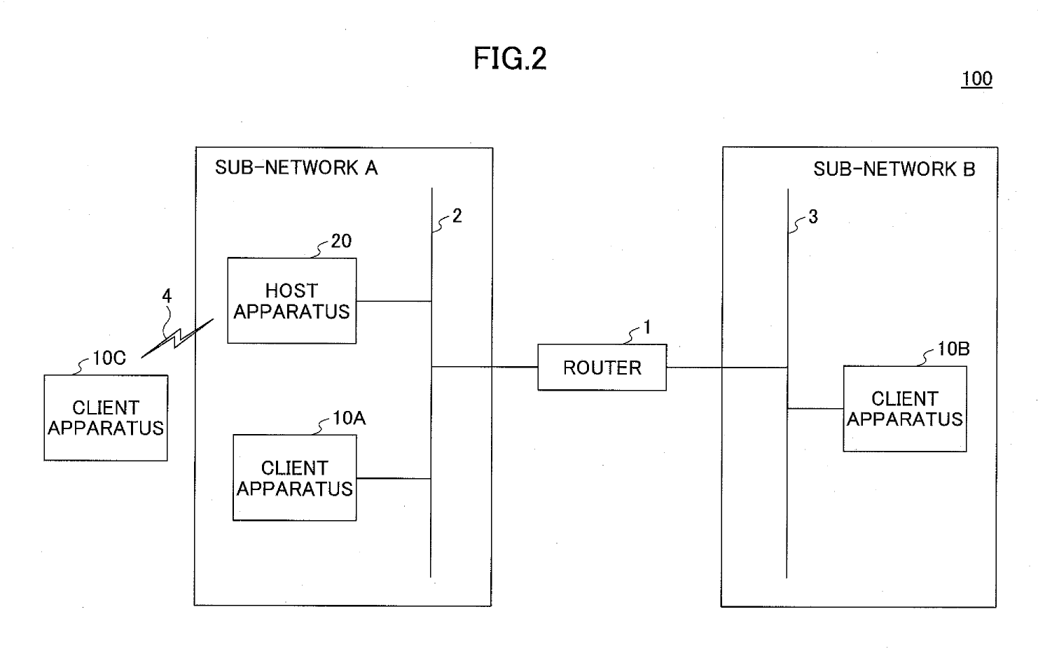

FIG. 2 is a block diagram schematically showing an exemplary configuration of the information communication system according to the first embodiment. In FIG. 2, the information communication system 100 includes a sub-network A and a sub-network B that are connected by a router 1.

The sub-network A includes the host apparatus 20 and a client apparatus 10A that are connected to a wired network 2. The sub-network B includes a client apparatus 10B that is connected to a wired network 3. The host apparatus 20 and the client apparatus 10B are connected to each other via the wired network 2, the router 1, and the wired network 3. The host apparatus 20 is also connected to a client apparatus 10C via a wireless LAN 4.

In the present embodiment, any of the client apparatuses 10A-10C may establish connections with the host apparatus 20 by obtaining the connection information included in the connection information sound output by the host apparatus 20. That is, in establishing connection with the host apparatus 20 according to the present embodiment, a distinction is not made between the client apparatus 10A within the same sub-network as the host apparatus 20, the client apparatus 10B that belongs to a different sub-network, and the client apparatus 10C that is connected to the host apparatus 20 via a wireless LAN.

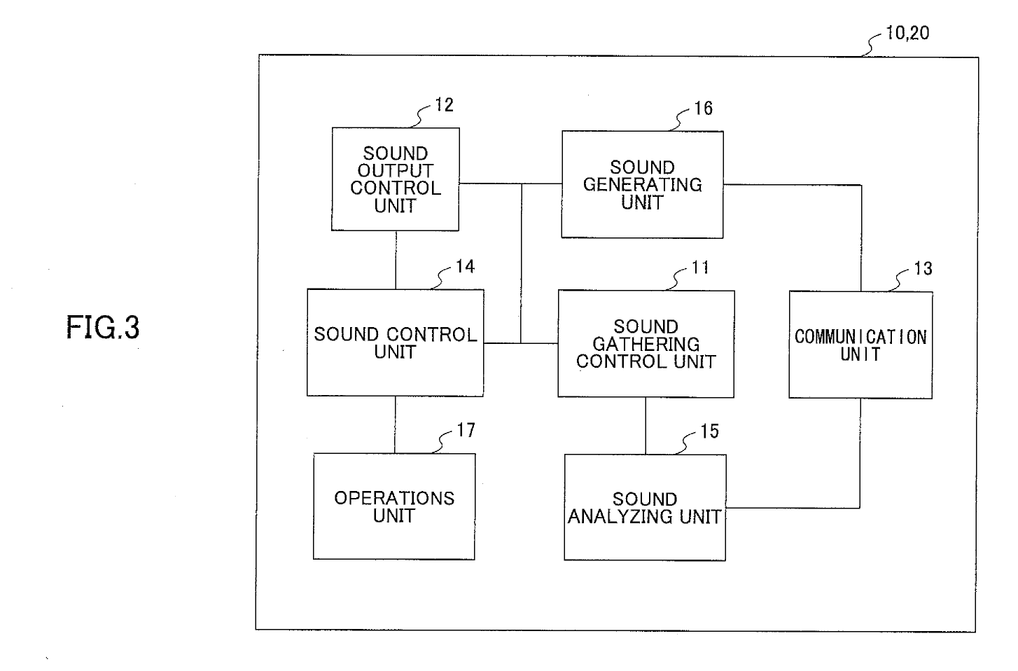

FIG. 3 is a block diagram showing exemplary functional features of the client apparatus and the host apparatus of the information communication system according to the first embodiment. In FIG. 3, the client apparatus 10 and the host apparatus 20 include a sound gathering control unit 11, a sound output control unit 12, a communication unit 13, a sound control unit 14, a sound analyzing unit 15, a sound generating unit 16, and an operations unit 17.

The sound gathering control unit 11 controls operations for gathering sound via a sound gathering unit such as a microphone and converting the gathered sound into an electric signal (sound data). The sound output control unit 12 controls operations for outputting a sound via a sound output unit such as a speaker.

The communication unit 13 establishes connection and exchanges data with other devices via a network For example, the communication unit 13 of the client apparatus 10 may establish connection with the host apparatus 20 via a network based on the connection information included in the connection information sound obtained from the host apparatus 20.

The communication unit 13 of the host apparatus 20 may store connection information and identification information unique to the host apparatus 20 (host ID), for example. The connection information may be information for establishing a connection with the host apparatus 20 via a network. For example, the connection information may be an IP address for establishing a connection with a LAN, an SSID and an IP address for establishing an ad hoc connection, or a MAC address for establishing a connection using Bluetooth, for example.

The sound control unit 14 controls operations of the sound analyzing unit 15 and the sound generating unit 16. For example, when sound data is obtained by the sound gathering control unit 11, the sound control unit 14 of the client apparatus 10 may prompt the sound analyzing unit 15 to analyze the sound data obtained by the sound gathering control unit 11.

In one preferred embodiment, the sound control unit 14 of the client apparatus 10 may control the sound data to be analyzed by the sound analyzing unit 15 by measuring the noise obtained by the sound gathering control unit 11 via the sound gathering unit and restricting the sound data to be analyzed based on the measured noise and a threshold value that is prescribed according to the distance between the host apparatus 20 and the client apparatus 10, for example.

In a further preferred embodiment, the sound control unit 14 may control the sound data to be analyzed based on the volume of the sound obtained by the sound gathering unit 11. For example, in a case where the distance between the host apparatus 20 and the client apparatus 10 is approximately 1 m, the sound control unit 14 of the client apparatus 10 may control the sound analyzing unit 15 to refrain from analyzing sound that is less than 50 dB. In this way, even when connection information sounds are obtained from plural host apparatuses 20, a desired host apparatus 20 may be determined based on the distance between the client apparatus 10 and each of the host apparatuses 20 and only the connection information sound of the desired host apparatus 20 may be analyzed.

The sound control unit 14 of the host apparatus 20 controls the sound generating unit 16 to generate a connection information sound. In one preferred embodiment, the sound control unit 14 of the host apparatus 20 may have the volume of the connection information sound set to a volume that would reach a predetermined range and may direct the sound generating unit 16 to adjust the volume of the connection information sound depending on the distance between the host apparatus 20 and the client apparatus 10.

In a further preferred embodiment, when the client apparatus 10 specifies the distance between the client apparatus 10 and the host apparatus 20 or a predetermined range such as inside a meeting room, the sound control unit 14 of the host apparatus 20 may direct the sound generating unit 16 to adjust the volume of the connection information sound accordingly so that the connection information sound may reach the specified distance or range, for example.

In another preferred embodiment, the sound control unit 14 of the host apparatus 20 may measure the noise obtained by the sound gathering control unit 11 via the sound gathering unit and direct the sound generating unit 16 to adjust the volume of the connection information sound according to the measured noise and the distance between the client apparatus 10 and the host apparatus 20.

In another preferred embodiment, the sound control unit 14 of the host apparatus 20 may direct the sound generating unit 16 to generate the connection information sound at a frequency within a high frequency band (e.g., at least 18 kHz) beyond the auditory frequency band so that noise will not be generated.

In another preferred embodiment, the sound control unit 14 of the host apparatus 20 may direct the sound generating unit 16 to generate the connection information sound at a frequency within a predetermined frequency band corresponding to the device type of the host apparatus 20 (e.g., projector, MFP, tablet terminal, PC). That is, the connection information sound of the host apparatus 20 may be generated at different frequency bands depending on the device type of the host apparatus 20. In this case, even when there are plural devices located near the client apparatus 10, the client apparatus 10 may be able to identify the types of these devices based on the connection information sounds from the devices so that confusion can be avoided, for example.

The sound analyzing unit 15 analyzes sound data obtained from the sound gathering control unit 11 and extracts information from the sound data. For example, the sound analyzing unit 15 of the client apparatus 10 may analyze sound data obtained via the sound gathering control unit 11 to obtain connection information included in a connection information sound output by the host apparatus 20 or obtain identification information unique to the host apparatus 20 included in an identification information sound (host ID sound) output by the host apparatus 20.

The sound generating unit 16 generates sound data to be output externally from a sound output unit such as a speaker and has the sound control unit 12 output the generated sound data. For example, the sound generating unit 16 of the host apparatus 20 may obtain information such as connection information and identification information unique to the host apparatus 20 from the communication unit 13 and embed the obtained information into sounds to generate a connection information sound and an identification information sound (host ID sound).

The operations unit 17 accepts commands and requests input by a user. For example, the user of the client apparatus 10 may input a command via the operations unit 17 to start a host search for searching the host apparatus 20. In one preferred embodiment, the user of the client apparatus 10 may specify a predetermined range via the operations unit 17 such as the distance between the client apparatus 10 and the host apparatus 20 with which connection is to be established or a specific meeting room in which the host apparatus 20 is located, for example. In another preferred embodiment, when connection information sounds from plural host apparatuses 20 are obtained, information of the plural host apparatuses 20 may be displayed so that the user may select the desired host apparatus 20 with which connection is to be established.

According to an aspect of the present embodiment, by using a connection information sound containing connection information, a connection may be established between a client apparatus 10 and a host apparatus 20 that are within a predetermined range.

It is noted that FIG. 3 illustrates an example in which tablet terminals or other devices having the same functions correspond to the client apparatus 10 and the host apparatus 20. In this case, either of the devices may act as the client apparatus 10 or the host apparatus 20. That is, one or more of the functional features shown in FIG. 3 may be selectively used depending on whether the device is operating as a client apparatus 10 or a host apparatus 20.

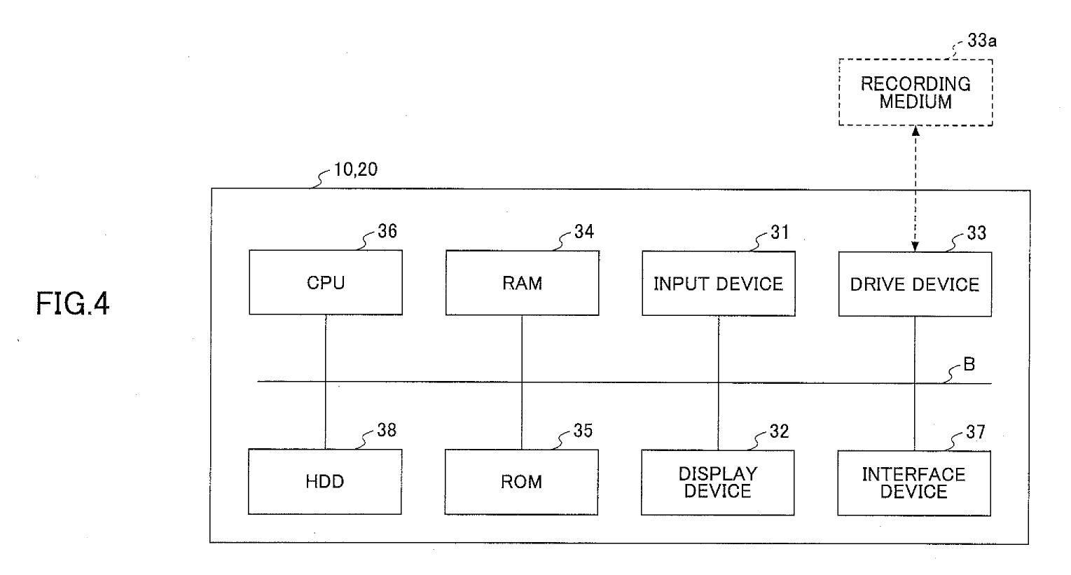

FIG. 4 is a block diagram showing exemplary hardware components of the client apparatus 10 and the host apparatus 20 according to the first embodiment.

In FIG. 4, the client apparatus 10 and the host apparatus 20 include an input device 31, a display device 32, a drive device 33, a RAM (Random Access Memory) 34, a ROM (Read-Only Memory) 35, and a CPU (Central Processing Unit) 36, an interface device 37, and a HDD (Hard Disk Drive) 38 that are connected to each other via a bus B.

The input device 31 may include a touch panel, for example, and is used to input operation signals to the client apparatus 10 or the host apparatus 20. The display device 32 includes a display for showing process results of the client apparatus 10 or the host apparatus 20.

The interface device 37 is an interface for connecting the client apparatus 10 or the host apparatus 20 to a transmission channel such a wired or wireless network. The client apparatus 10 and the host apparatus 20 may exchange data with other devices via the interface device 37.

The HDD 38 is a non-volatile storage device that stores programs and data. For example, the HDD 38 may store an OS (Operating System) such as Windows (registered trademark) or Unix (registered trademark) for controlling overall operations of the client apparatus 10 or the host apparatus 20 and applications for providing various functions and services on the system. The HDD 38 may manage the stored programs and data in a predetermined file system and/or a database, for example.

The drive device 33 is an interface for a removable recording medium 33a. The client apparatus 10 and the host apparatus 20 may read and/or write on the recording medium 33a via the drive device 33. The recording medium 33a may be a SD (Secure Digital) memory card or a USB (Universal Serial Bus) memory, for example.

The ROM 35 is a non-volatile semiconductor memory (storage device) that is capable of retaining data even when the power is switched off. The ROM 35 may store programs and data such as BIOS (Basic Input/Output System) software that is executed upon starting the client apparatus 10 or the host apparatus 20, system settings, and network settings, for example.

The RAM 34 is a volatile semiconductor memory (storage device) that temporarily stores programs and data. The CPU 36 is a processing unit that fetches programs and data from the non-volatile storage devices such as the HDD 38 and the ROM 35 and stores the fetched data or programs in the RAM 34 to execute apparatus control programs and installed programs.

In one preferred embodiment, the host apparatus 20 may include a projector that is connected to the bus B for projecting image data on a screen, for example.

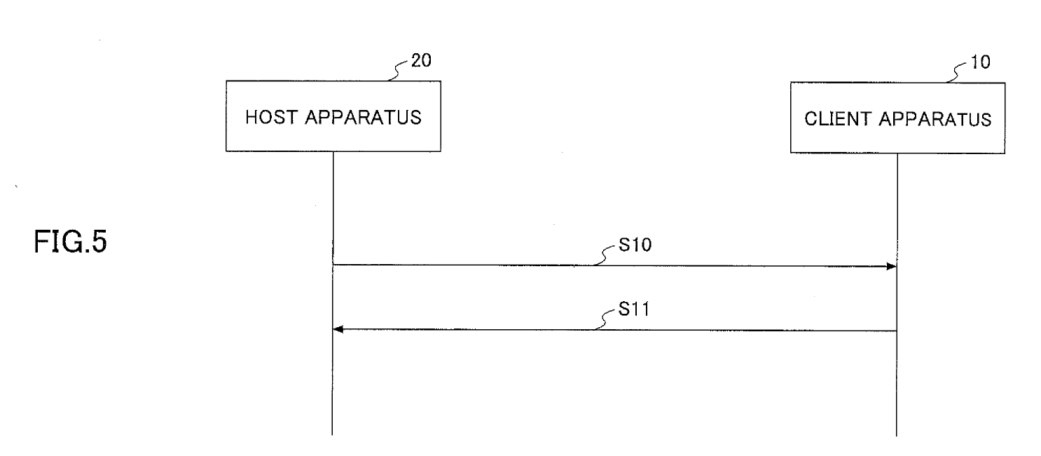

FIG. 5 is a sequence chart showing an exchange between the client apparatus 10 and the host apparatus 20 according to the first embodiment.

In FIG. 5, the host apparatus 20 outputs a connection information sound having connection information for establishing a connection with the host apparatus 20 embedded therein via a sound output unit such as a speaker (S10). In turn, the client apparatus 10 obtains the connection information sound output by the host apparatus 20 via a sound gathering unit such as a microphone, analyzes the connection information sound to obtain the connection information, and establishes a connection with the host apparatus 20 via a network using the connection information (S11).

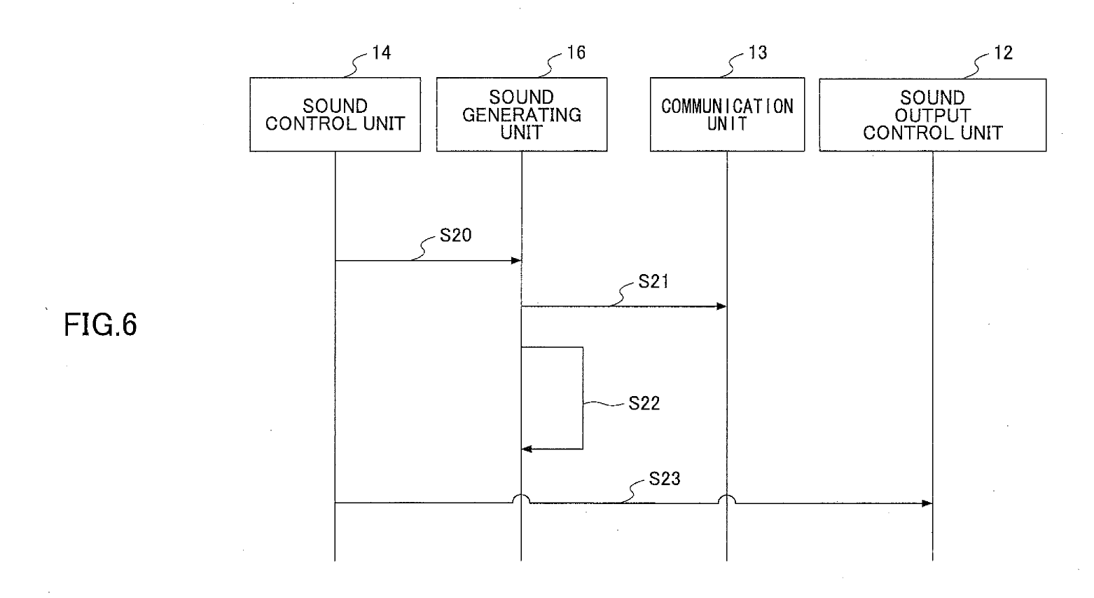

FIG. 6 is a sequence chart showing exemplary process steps of the host apparatus 20 according to one aspect of the first embodiment. It is noted that the exemplary process steps shown in FIG. 6 are executed by the sound control unit 14, the sound generating unit 16, the communication unit 13, and the sound output control unit 12 of the host apparatus 20.

In FIG. 6, when the sound control unit 14 of the host apparatus 20 sends a request to the sound generating unit 16 to generate a connection information sound (S20), the sound generating unit 16 obtains connection information for establishing a connection with the host apparatus 20 from the communication unit 13 (S21) and embeds the obtained connection information into sounds to generate the connection information sound (S22).

In one preferred embodiment, the sound generating unit 16 may embed the connection information into sounds using the DTMF (Dual-Tone Multi-Frequency) signaling method.

In another preferred embodiment, the sound generating unit 16 may embed the connection information into sounds using a frequency in the high frequency band (e.g., at least 18 kHz) outside the auditory frequency band. In this case, the connection information sound would not be audible to the user so that a connection may be established without the user becoming aware of the connection information sound. It is noted that the connection information may be embedded into conventional sounds in other embodiments of the present invention.

Upon receiving notification from the sound generating unit 16 that the connection information sound has been generated, the sound control unit 14 sends a request to the sound output control unit 12 to output the connection information sound (S23). In turn, the sound output control unit 12 prompts a sound output unit such as a speaker to output the connection information sound.

In certain preferred embodiments, the above process of generating the connection information sound may be triggered by a command input by a user via the operations unit 17 or the system startup of the host apparatus 20, for example. In another embodiment, which is described below as the second embodiment of the present invention, the above process of generating the connection information sound may be triggered when the host apparatus 20 obtains a requesting sound for requesting the output of the connection information sound from the client apparatus 10.

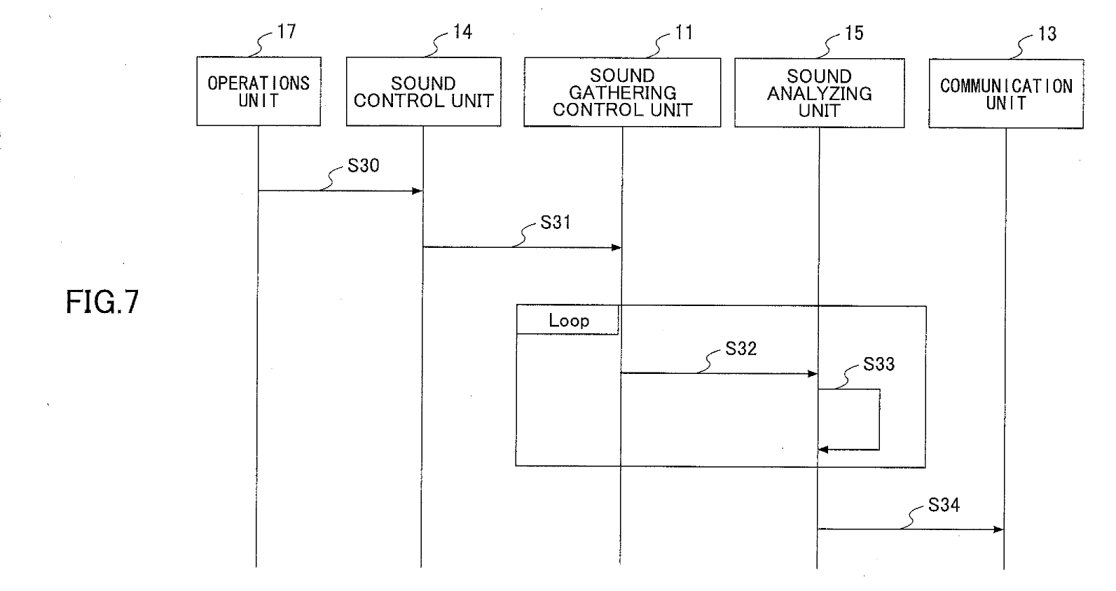

FIG. 7 is a sequence chart showing exemplary process steps of the client apparatus 10 according to one aspect of the first embodiment. It is noted that the exemplary process steps shown in FIG. 7 are executed by the operations unit 17, the sound control unit 14, the sound gathering control unit 11, the sound analyzing unit 15, and the communication unit 13 of the client apparatus 10.

As is shown in FIG. 7, when a user inputs a command to start a search for the host apparatus 20 via the operations unit 17 of the client apparatus 10, for example, the operations unit 17 sends a request to the sound control unit 14 to obtain the connection information sound output from the host apparatus 20 (S30). In turn, the sound control unit 14 directs the sound gathering control unit 11 to start sound gathering operations (S31). The sound gathering control unit 11 converts sounds gathered by a sound gathering unit such as a microphone into sound data and outputs the sound data to the sound analyzing unit 15 (S32).

The sound analyzing unit 15 analyzes the sound data obtained from the sound gathering control unit 11 (S33), obtains connection information included in the connection information sound, and outputs the connection information to the communication unit 13 (S34).

In one preferred embodiment where the connection information is embedded into sound using the DTMF signaling method, a sound including multiple specific frequencies is generated as the connection information sound and the sound analyzing unit 15 may analyze the connection information sound using the FFT (Fast Fourier Transform) analysis method to extract the connection information from the frequencies included in the connection information sound.

It is noted that steps S32 and S33 that are performed by the sound gathering control unit 11 and the sound analyzing unit 15 form a loop that is repeated until the sound analyzing unit 15 obtains the connection information. The communication unit 13 uses the connection information obtained by the sound analyzing unit 15 to establish a connection with the host apparatus 20 via a network.

In the following, the manner in which the sound generating unit 16 of the host apparatus 20 embeds connection information into sound data is described.

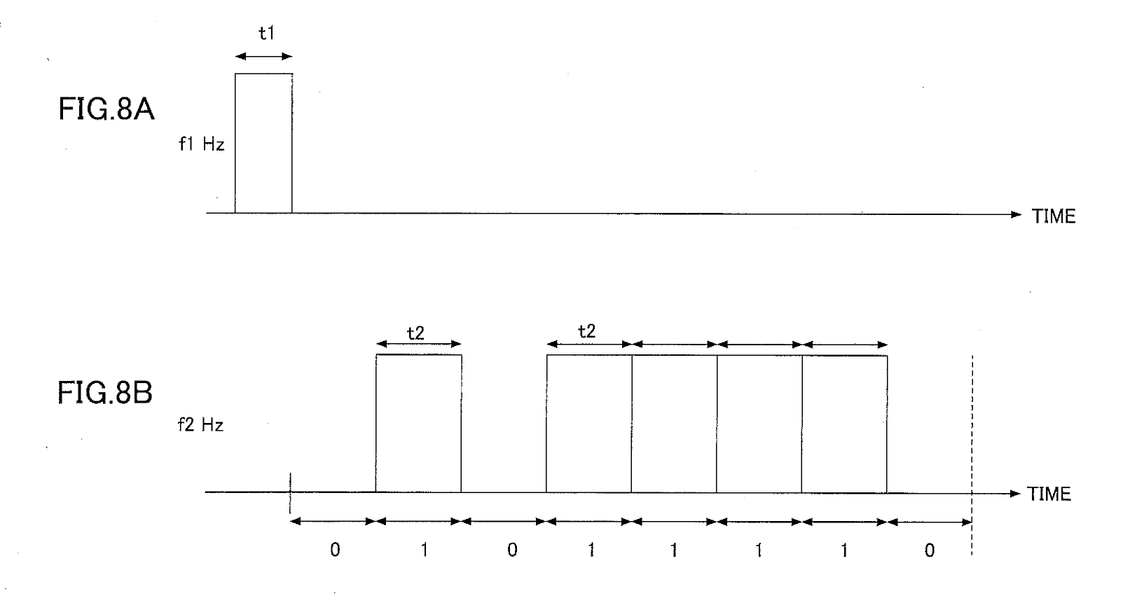

FIGS. 8A and 8B are diagrams illustrating an exemplary method of embedding connection information into sound data. It is noted that FIGS. 8A and 8B illustrate an example of embedding the number “94” into sound data.

FIG. 8A illustrates a sound having a predetermined frequency of f1 Hz that is output for a predetermined time period t1. In one embodiment, the sound generating unit 16 of the host apparatus 20 may output the sound with the predetermined frequency f1 Hz for the predetermined time period t1 to signal the start of the embedded information.

FIG. 8B illustrates sounds having a predetermined frequency of f2 Hz that are output at intervals of time period t2. In one embodiment, the sound generating unit 16 of the host apparatus 20 may output the sound with the predetermined frequency f2 Hz for the predetermined time period t2 to signal the binary digit “1” and refrain from outputting the sound with the predetermined frequency f2 Hz for the predetermined time period t2 to signal the binary digit “0.” In the present example, the sound generating unit 16 converts the number “94” into a binary number “01011110” as binary information.

In a preferred embodiment, after the sound with the frequency f1 Hz is output for the time period t1, the sound generating unit 16 controls the output of sounds at the frequency f2 Hz at intervals of time period t2 (i.e., either outputs the sound or refrains from outputting the sound) to signal the binary information “01011110.” In this way, the sound generating unit 16 may embed the binary information “01011110” corresponding to the number “94” into sound data.

In the case of embedding the IP address of the host apparatus 20, the sound generating unit 16 may continue generating the sound to signal a four-digit number, for example.

It is noted that the sound output duration is proportional to the amount of information being embedded in the sound data. In one embodiment, in addition to providing a code signaling the start of the sound data, the sound generating unit 16 may embed a special code signaling the end of the sound data so that the client apparatus 10 receiving the sound data may be able to determine the end of the sound data, for example. In this case, the sound analyzing unit 15 of the client apparatus 10 may identify the codes signaling the beginning and the end of the sound data and obtain the connection information from the sound data in between the beginning and end codes.

In the following, the manner in which the sound analyzing unit 15 of the client apparatus 10 extracts the connection information from sound data is described.

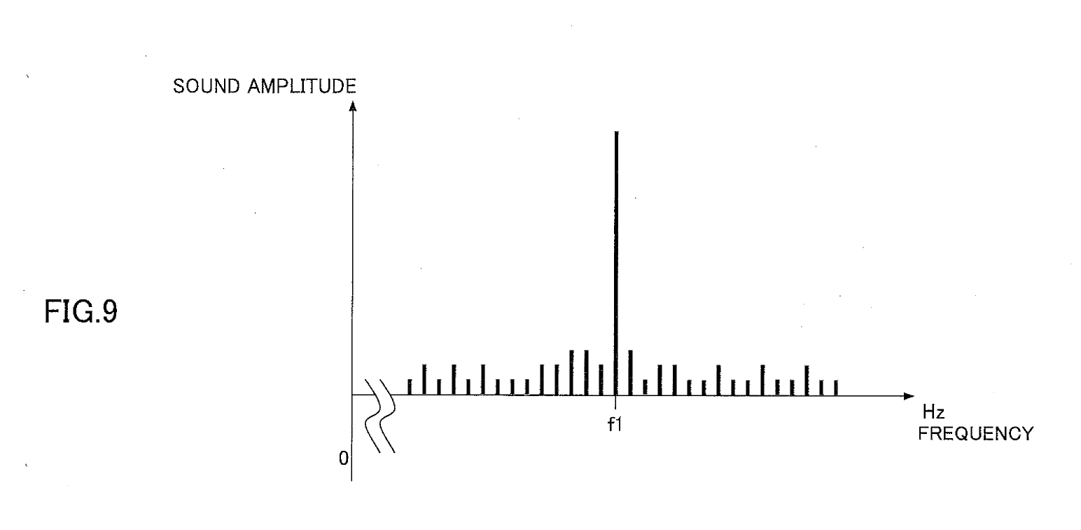

FIG. 9 is a graph illustrating an exemplary method of extracting connection information from sound data. In the graph of FIG. 9, the horizontal axis represents the frequency (Hz) and the vertical axis represents the sound amplitude.

In the case where information is embedded into sound data in the manner shown in FIGS. 8A and 8B, the sound analyzing unit 15 of the client apparatus 10 performs an FFT on the sound data obtained by the sound gathering control unit 11 to obtain the frequency components of the sound data and determine whether a sound with the frequency f1 Hz is output, for example.

As is shown in FIG. 9, when a sound with the frequency f1 Hz is output, a peak appears at the f1 Hz frequency region. After detecting the sound with the frequency f1 Hz, the sound analyzing unit 15 may perform the FFT on the sound data to determine whether a sound with the frequency f2 Hz is output. The sound analyzing unit 15 detects “1” when a sound with the frequency f2 Hz is output for time period t2 and detects “0” when a sound with the frequency f2 Hz is not output.

After obtaining the binary number “0101110” embedded in the sound data, the sound analyzing unit 15 converts the binary number into a decimal number to obtain the number “94.” In the case of obtaining an IP address, the sound analyzing unit 15 may extract a four-digit decimal number in the manner described above.

It is noted that there may be cases in which the embedded information cannot be accurately extracted due to noise during transmission, for example. Accordingly, to improve accuracy upon authenticating the embedded information, in one preferred embodiment, the sound analyzing unit 15 of the client apparatus 10 may be configured to read and analyze the same signal a prescribed number of times and statistically evaluate the plural analysis results to determine the values corresponding to the embedded information. In another preferred embodiment, the sound control unit 14 of the host apparatus 20 may be controlled to repetitively output the same signal.

In other preferred embodiments, conventional error detection codes and/or error correction codes may be used to improve the accuracy in extracting the values corresponding to the embedded information.

In the following, exemplary process steps of the client apparatus 10 and the host apparatus 20 according to another aspect of the first embodiment are described.

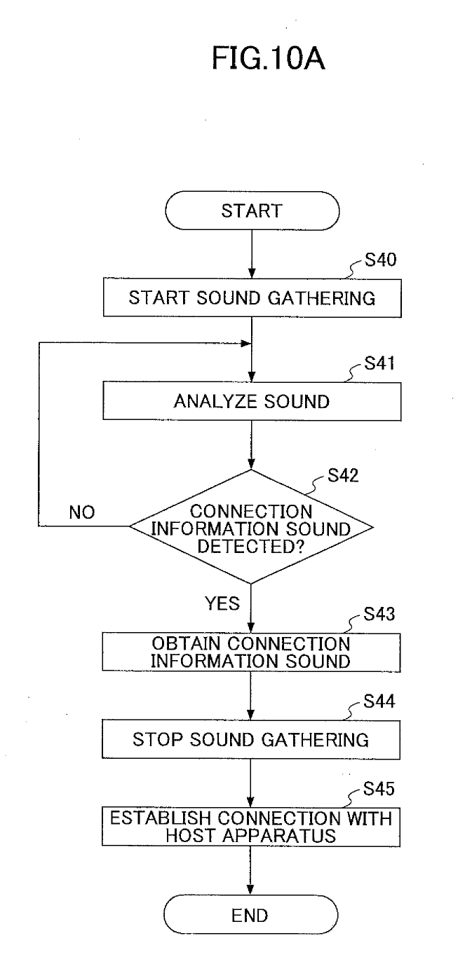

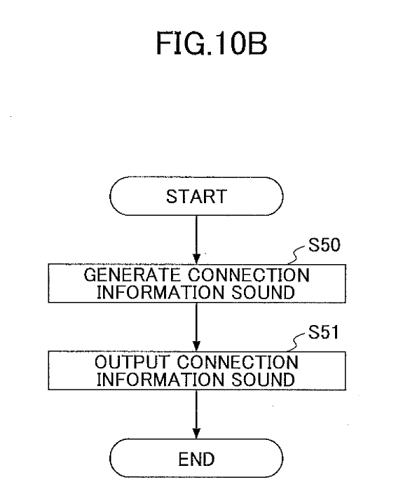

FIG. 10A is a flowchart showing exemplary process steps of the client apparatus 10. In FIG. 10A, the client apparatus 10 has the sound gathering control unit 11 prompt a sound gathering unit such as a microphone to start gathering sounds from the surrounding (S40) and has the sound analyzing unit 15 analyze the sounds gathered by the sound gathering control unit 11 (S41).

The sound analyzing unit 15 determines whether a connection information sound output by the host apparatus 20 has been detected (S42), and upon determining that a connection information sound has been detected (YES in S42), obtains the connection information included in the connection information sound (S43).

Then, the sound gathering control unit 11 ends the sound gathering operations performed by the sound gathering unit (S44), the communication unit 13 establishes connection with the host apparatus 20 via a network using the connection information (S45), and the process of the client apparatus 10 is ended. When the sound analyzing unit 15 determines that a connection information sound has not been detected (NO in S42), the process returns to step S41 and proceeds from thereon.

FIG. 10B is a flowchart showing exemplary process steps of the host apparatus 20. In FIG. 10B, the host apparatus 20 has the sound generating unit 16 generate a connection information sound (S50) and has the sound output control unit 12 prompt a sound output unit such as a speaker to output the connection information sound (S51) after which it ends the process.

In one preferred embodiment, the process steps of the host apparatus 20 may be started upon obtaining a requesting sound from the client apparatus 10 as is described below in connection with the second embodiment. In another preferred embodiment, the process steps of the host apparatus 20 may be started in response to a command input by a user via the operations unit 17. In yet another preferred embodiment, the process steps of the host apparatus 20 may be triggered by the system startup.

### Second Embodiment

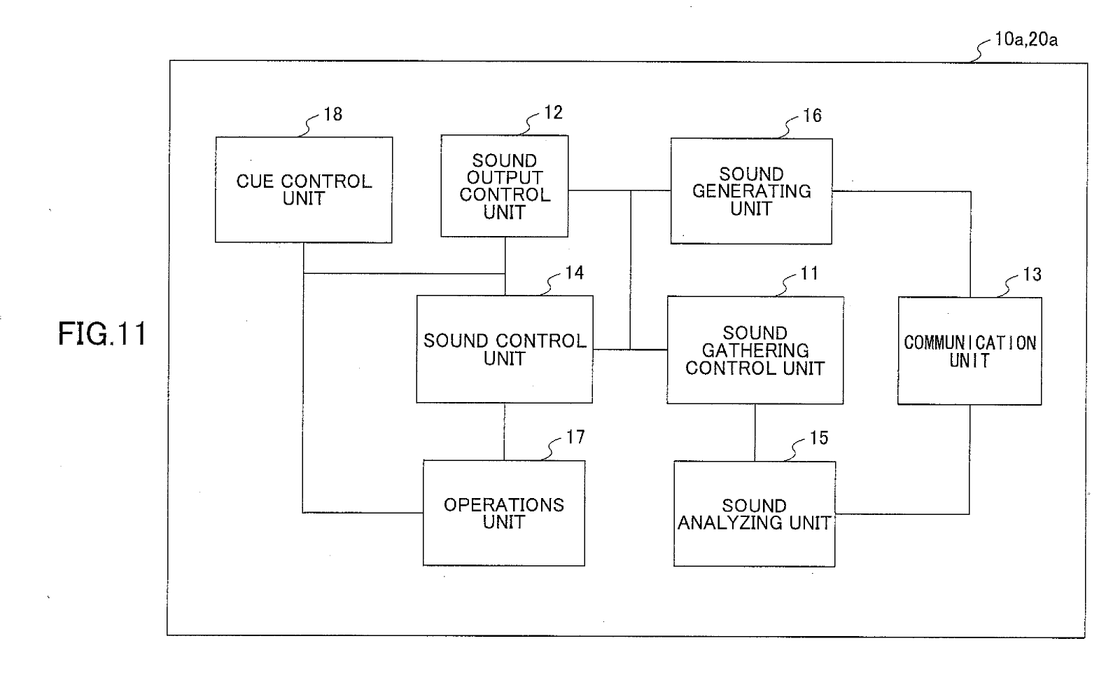

FIG. 11 is a block diagram showing exemplary functional features of a client apparatus 10a and a host apparatus 20a according to a second embodiment of the present invention. It is noted that features of the client apparatus 10a and the host apparatus 20a that are identical to those shown in FIG. 3 are given the same reference numerals and their descriptions are omitted.

FIG. 11 illustrates an example in which tablet terminals or other devices having the same functions correspond to the client apparatus 10a and the host apparatus 20a. In this case, either of the devices may act as the client apparatus 10a or the host apparatus 20a. That is, one or more of the functional features shown in FIG. 11 may be selectively used depending on whether the device is operating as the client apparatus 10a or the host apparatus 20a.

In FIG. 11, the client apparatus 10a and the host apparatus 20a according to the second embodiment include the sound gathering control unit 11, the sound output control unit 12, the communication unit 13, the sound control unit 14, the sound analyzing unit 15, the sound generating unit 16, the operations unit 17, and a cue control unit 18.

In the second embodiment, the sound control unit 14 of the client apparatus 10a receives a command from the cue control unit 18 to generate a requesting sound for requesting the output of a connection information sound by the host apparatus 20a and directs the sound generating unit 16 to generate the requesting sound. In one preferred embodiment, the sound control unit 14 of the client apparatus 10a may direct the sound generating unit 16 to generate the requesting sound using a sound within a frequency band that does not overlap with the frequency band of the connection information sound output by the host apparatus 20a.

In another preferred embodiment, the sound control unit 14 of the client apparatus 10a may direct the sound output control unit 12 to output the requesting sound generated by the sound generating unit 16 for a predetermined time period. In yet another preferred embodiment, when the sound control unit 14 of the client apparatus 10a determines that the host apparatus 20 has not output a connection information sound within a prescribed time period after the requesting sound has been output by the sound output control unit 12, the sound control unit 14 may direct the sound generating unit 16 to output the requesting sound again up to a prescribed number of times.

The sound control unit 14 of the host apparatus 20a directs the sound analyzing unit 15 to analyze sound data obtained by the sound gathering control unit 11 and determines whether a requesting sound from the client apparatus 10a has been detected. Upon determining that the requesting sound has been detected, the sound control unit 14 of the host apparatus 20a sends a notification to the cue control unit 18 that the requesting sound has been obtained.

The sound control unit 14 of the host apparatus 20a directs the sound generating unit 16 to generate a connection information sound upon receiving a command from the cue control unit 18. In one preferred embodiment, the sound control unit 14 of the host apparatus 20a may direct the sound generating unit 16 to adjust the volume of the connection information sound according to the volume of the requesting sound obtained from the client apparatus 10a.

The sound analyzing unit 15 of the host apparatus 20a analyzes the sound data obtained by the sound gathering unit 11 in response to a command from the sound control unit 14 and detects the requesting sound from the client apparatus 10a.

The sound generating unit 16 of the client apparatus 10a generates a requesting sound for requesting the output of a connection information sound by the host apparatus 20a in response to a command from the sound control unit 14.

The cue control unit 18 may control operations for obtaining a connection information sound, detecting a predetermined cue (trigger), or outputting the connection information sound, for example.

The cue control unit 18 of the client apparatus 10a may direct the sound control unit 14 to generate a requesting sound (cue sound) for requesting the output of a connection information signal by the host apparatus 20a in response to a user command to start a search for the host apparatus 20a input via the operations unit 17, for example.

The cue control unit 18 of the host apparatus 20a may direct the sound control unit 14 to output a connection information sound upon detecting a predetermined cue (trigger) such as a requesting sound from the client apparatus 10a, a user command input via the operations unit 17, or the system start-up. In one preferred embodiment, the cue control unit 18 of the host apparatus 20 may direct the sound control unit 14 to output a connection information sound upon detecting the presence of the client apparatus 10a using an infrared light sensor, an ultrasonic wave sensor, or a visible light sensor, for example.

According to an aspect of the present embodiment, the timing at which the host apparatus 20a outputs the connection information sound may be determined by a predetermined cue (trigger) so that the host apparatus 20a may not have to constantly output the connection information sound and may thereby save energy.

In the following, an exchange between the client apparatus 10a and the host apparatus 20a according to the second embodiment is described.

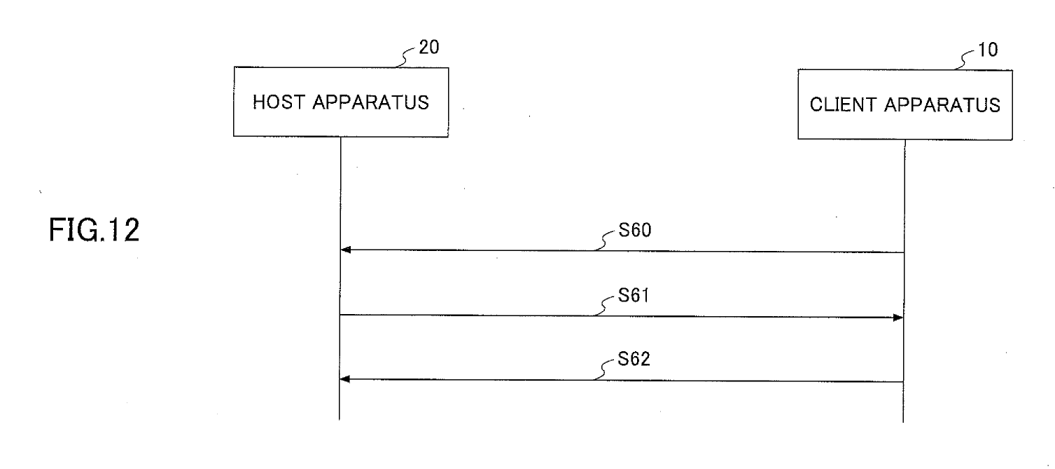

FIG. 12 is a sequence chart showing an exemplary exchange between the client apparatus 10a and the host apparatus 20a.

In FIG. 12, the client apparatus 10a outputs a requesting sound to the host apparatus 20a through control operations of the cue control unit 18 (S60), the host apparatus 20a obtains the requesting sound from the client apparatus 10a through control operations of the cue control unit 18, and outputs a connection information sound (S61). The client apparatus 10a obtains the connection information included in the connection information sound output by host apparatus 20a, and establishes a connection with the host apparatus 20a via a network using the obtained connection information (S62).

In the following, exemplary process steps of the client apparatus 10a and the host apparatus 20a according to one aspect of the second embodiment are described.

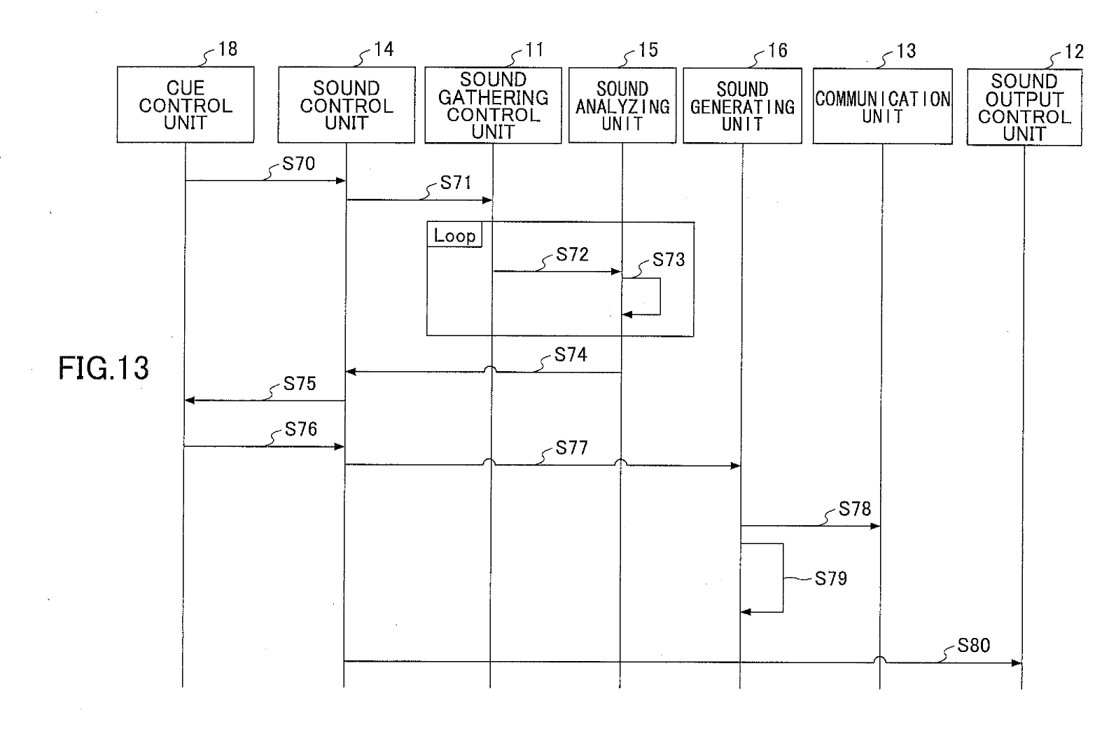

FIG. 13 is a sequence chart showing exemplary process steps of the host apparatus 20a. It is noted that the exemplary process steps shown in FIG. 13 are executed by the cue control unit 18, the sound generating unit 14, the sound gathering unit 11, the sound analyzing unit 15, the sound generating unit 16, the communication unit 13, and the sound output control unit 12 of the host apparatus 20a.

In the second embodiment, the host apparatus 20a performs operations for obtaining a requesting sound that is output by the client apparatus 10a. It is noted that steps S77-S80 shown in FIG. 13 that are performed after obtaining the requesting sound may be identical to steps S20-S23 shown in FIG. 6 so that their descriptions are omitted.

In FIG. 13, upon detecting a predetermined cue (trigger) such as the system startup, the cue control unit 18 of the host apparatus 20a directs the sound control unit 14 to start gathering sounds (S70). In turn, the sound control unit 14 outputs a command to the sound gathering control unit 11 to start sound gathering operations (S71).

The sound gathering control unit 11 obtains sounds gathered by a sound gathering unit such as a microphone, converts the gathered sounds into sound data, and outputs the sound data to the sound analyzing unit 15 (S72). The sound analyzing unit 15 then analyzes the sound data obtained by the sound gathering control unit 11 (S73). Upon obtaining a requesting sound output by the client apparatus 10a from the sound data, the sound analyzing unit 15 sends a notification to the sound control unit 14 that the requesting sound has been obtained (S75). The sound control unit 14 then sends the notification to the cue control unit 18 (S76).

Upon receiving the notification that the requesting sound has been obtained, the cue control unit 18 sends a request to the sound control unit 14 to generate a connection information sound (S76). It is noted that steps S72 and S73 performed by the sound gathering control unit 11 and the sound analyzing unit 15 form a loop that is repeated until a requesting sound from the client apparatus 10a is obtained.

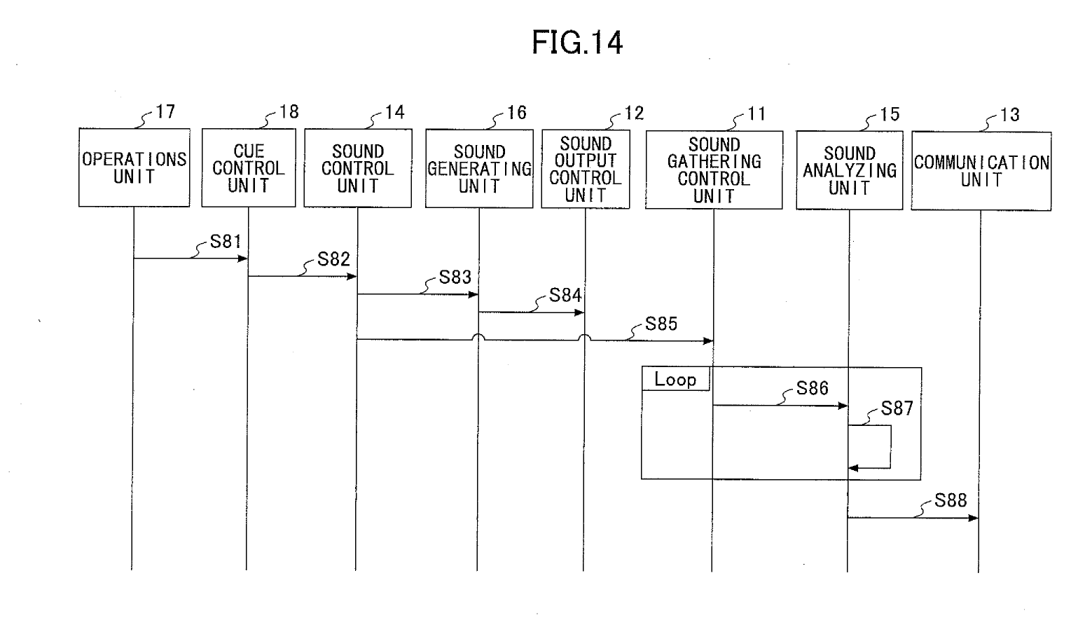

FIG. 14 is a sequence chart showing exemplary process steps of the client apparatus 10a. It is noted that the exemplary process steps shown in FIG. 14 are executed by the operations unit 17, the cue control unit 18, the sound control unit 14, the sound generating unit 16, the sound output control unit 12, the sound gathering control unit 11, the sound analyzing unit 15, and the communication unit 13 of the client apparatus 10a.

In the second embodiment, the client apparatus 10a performs operations for outputting a requesting sound for requesting the connection information sound of the host apparatus 20a. It is noted that steps S85-S88 of FIG. 14 that are performed after outputting the requesting sound may be identical to steps S31-S34 of FIG. 7 so that their descriptions are omitted.

In FIG. 14, when a user command to start a search for the host apparatus 20a is input via the operations unit 17 of the client apparatus 10a, for example, the operations unit 17 directs the cue control unit 18 to generate a requesting sound (S81). In turn, the cue control unit 18 directs the sound control unit 14 to generate the requesting sound (S82).

When the sound control unit 14 of the client apparatus 10a directs the sound generating unit 16 to generate the requesting sound (S83), the sound generating unit 16 generates the requesting sound (S84), and the sound control unit 12 prompts a sound output unit such as a speaker to output the requesting sound.

In the following, exemplary process steps of the client apparatus 10a and the host apparatus 20a according to another aspect of the second embodiment are described.

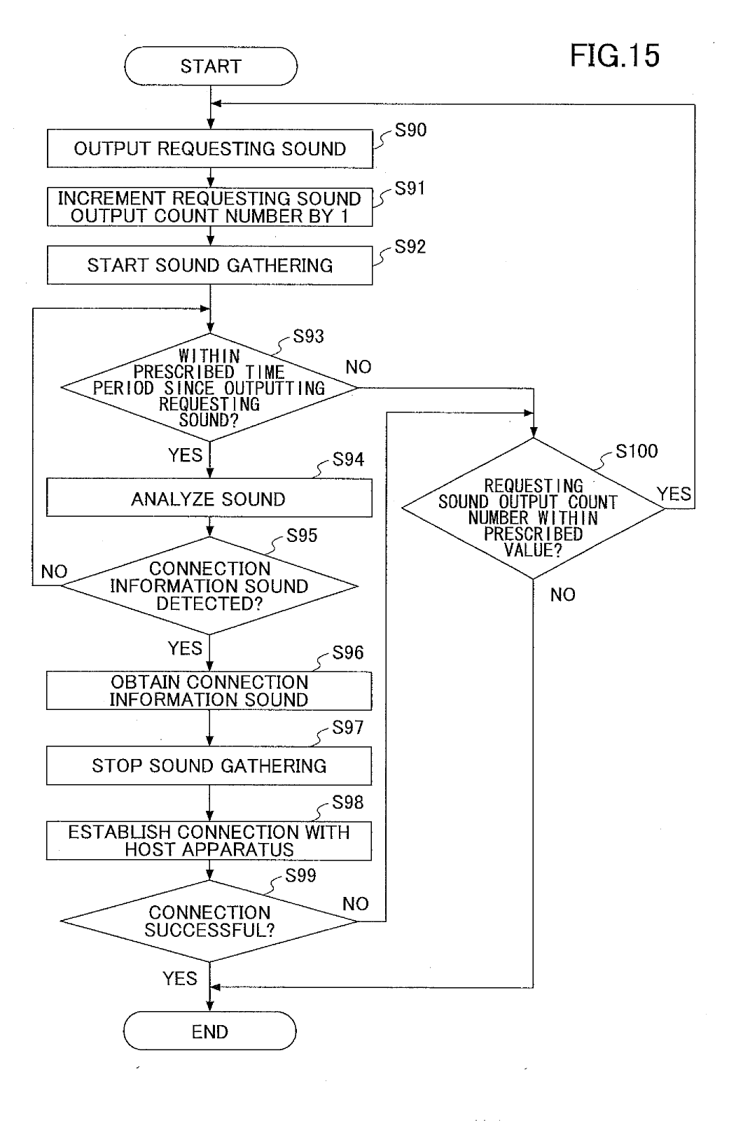

FIG. 15 is a flowchart illustrating exemplary process steps of the client apparatus 10a.

In the present embodiment, when the host apparatus 20a is unable to obtain the requesting sound output by the client apparatus 10a due to influences from temporary noise, for example, and the connection information sound is not output from the host apparatus 20a, the client apparatus 10a may output the requesting sound again to compensate for the failure of the host apparatus 20a to obtain the requesting sound the previous time.

In FIG. 15, the client apparatus 10a outputs a requesting sound generated by the sound generating unit 16 by having the sound output control unit 12 prompt a sound output unit such as a speaker to output the requesting sound (S90). The sound control unit 14 then increments a requesting sound output count number by one (S91).

Then, the sound gathering control unit 11 prompts a sound gathering unit such as a microphone to start gathering the connection information sound output by the host apparatus 20a (S92). The sound control unit 14 determines whether it is still within a prescribed time period since the requesting sound has been output in step S90 (S93).

When the sound control unit 14 determines that it is still within the prescribed time period since the requesting sound has been output (YES in S93), the sound control unit 14 directs the sound analyzing unit 15 to analyze the sound data obtained by the sound gathering control unit 11 (S94) and determines whether the connection information sound has been detected (S95).

When the sound control unit 14 determines that it is no longer within the prescribed time period since the requesting sound has been output in step S90 (NO in S93), the sound control unit 14 determines whether the requesting sound output count number is within a prescribed value (S100). When the sound control unit 14 determines that the requesting sound output count number is within the prescribed value (YES in S100), the process returns to step S90. When the sound control unit 14 determines that the requesting sound output count number is not within the prescribed value (NO in step S100), the process is ended.

When the sound control unit 14 determines via the sound analyzing unit 15 that the connection information sound has not been detected (NO in S95), the process returns to step S93. On the other hand, when the sound control unit 14 determines via the sound analyzing unit 15 that the connection information sound has been detected (YES in S95), the process proceeds to operations for obtaining the connection information included in the connection information sound (S96).

Then, the sound gathering control unit 11 ends the sound gathering operations by the sound gathering unit (S97), and the communication unit 13 establishes connection with the host apparatus 20a via a network using the connection information (S98).

The communication unit 13 determines whether a connection with the host apparatus 20a has been successfully established (S99), and when it is determined that connection has been successfully established (YES in S99), the process is ended. When the communication unit 13 determines that connection with the host apparatus 20a has not been successfully established (NO in S99), the process proceeds to step S100.

According to an aspect of the present embodiment, the sound control unit 14 of the client apparatus 10a records the number of times the requesting sound has been output and determines whether a connection information sound has been output from the host apparatus 20a within a prescribed time period since the requesting sound has been output. When the sound control unit 14 determines that the connection information sound has not been output from the host apparatus 20a within the prescribed time period, the sound control unit 14 directs the sound generating unit 16 to output the requesting sound again up to a prescribed number of times.

In one preferred embodiment, when the requesting sound output count number has exceeded the prescribed number, the sound output control unit 14 may make adjustments to raise the volume of the requesting sound before resuming the process from step S90. In another preferred embodiment, the sound control unit 14 may direct the sound gathering unit such as a microphone via the sound gathering control unit 11 to gather noise and adjust the volume of the requesting sound according to the gathered noise or the distance between the client apparatus 10a and the host apparatus 20a before outputting the requesting sound again.

In another preferred embodiment, the sound control unit 14 of the host apparatus 20a may adjust the volume of the connection information sound when the client apparatus 10a does not establish connection with the host apparatus 20a within a predetermined time period since the requesting sound is obtained from the client apparatus 10a. The sound control unit 14 of the host apparatus 20 may then output the connection information sound again to compensate for the failure of the client apparatus 10a to obtain the connection information sound and/or establish connection with the host apparatus 20a.

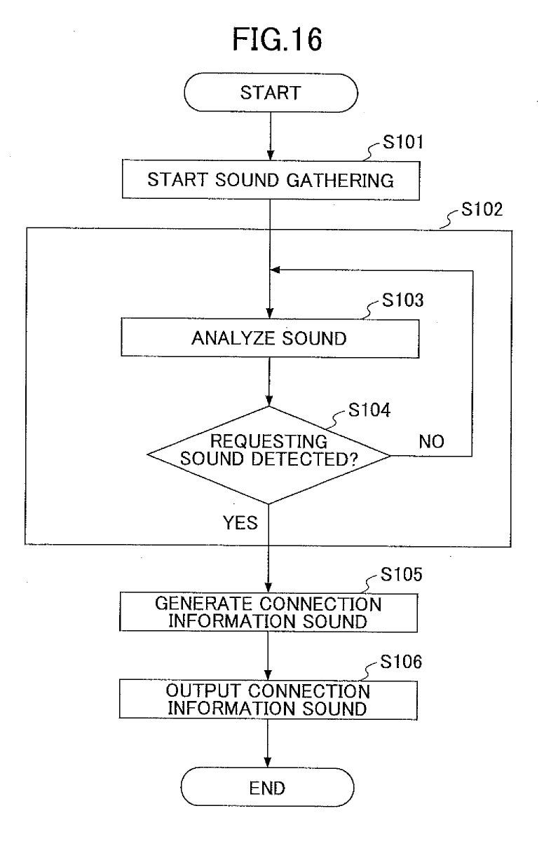

FIG. 16 is a flowchart illustrating exemplary process steps of the host apparatus 20a.

In FIG. 16, when the system is started, for example, the host apparatus 20a has the cue control unit 18 direct the sound gathering control unit 11 to start sound gathering operations, and in turn, the sound gathering control unit 11 prompts a sound gathering unit such as a microphone to start gathering sounds (S101). The process then proceeds to sub process step S102.

In sub process step S102, the sound control unit 14 directs the sound analyzing unit 15 to analyze the gathered sounds (S103), and determines whether a requesting sound has been detected (S104). When the sound control unit 14 determines that the requesting sound has not been detected (NO in S104), the process returns to step S103.

When the sound output unit 14 determines that the requesting sound has been detected (YES in S104), the sound control unit 14 has the sound generating unit 16 generate a connection information sound (S105) and has the sound output control unit 12 prompt a sound output unit such as a speaker to output the connection information sound (S106) after which the process is ended.

In one preferred embodiment, the host apparatus 20a may accommodate for a case in which requesting sounds are output by plural client apparatuses 10a and may continue the sound gathering operations and the sub process step S102.

[Predetermined Cue]

In the following, examples of a predetermined cue (trigger) for prompting the output of the connection information sound are described.

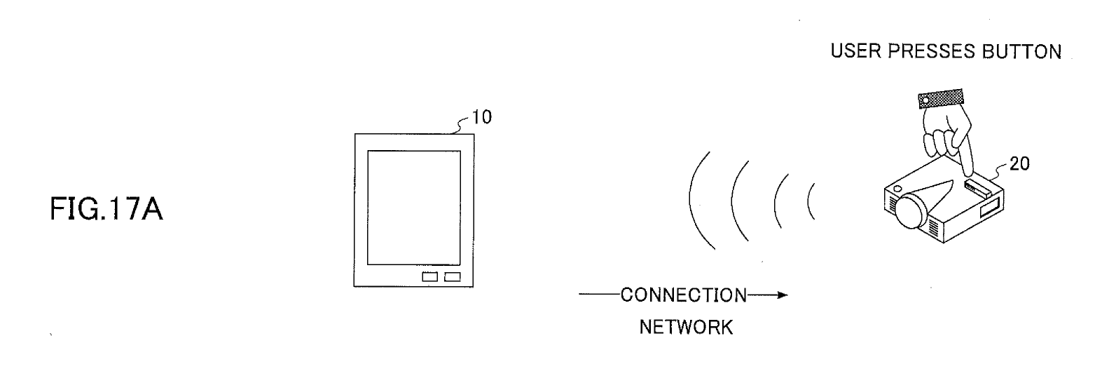

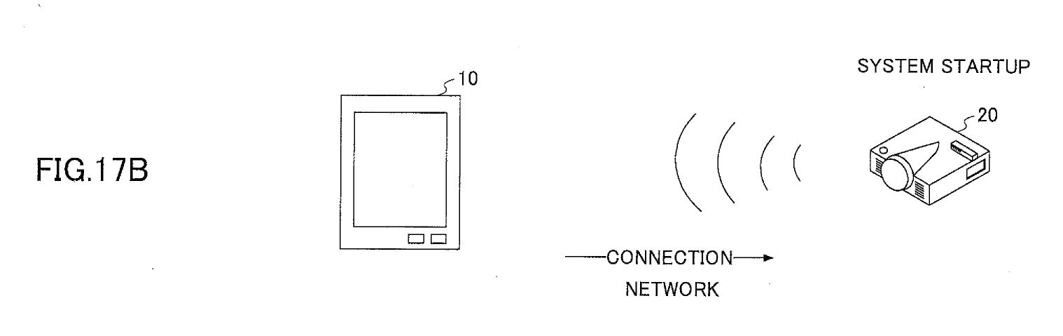

FIG. 17A illustrates an example in which a user command input via the operations unit 17 corresponds to the predetermined cue for outputting the connection information sound.

In this case, for example, the process steps S20-S23 of FIG. 6 for generating a connection information sound may be triggered when the user inputs a command via the operations unit 17.

In one modified embodiment, the host apparatus 20 may include the cue control unit 18 so that the cue control unit 18 may detect the user command input via the operations unit 17 and direct the sound control unit 14 to generate a connection information sound.

FIG. 17B illustrates an example in which the host apparatus 20 continuously outputs the connection information sound while the system is operating.

In this case, for example, the host apparatus 20 may have the sound control unit 14 start the process of generating a connection information sound upon detecting the system startup.

In one modified embodiment, the host apparatus 20 may include the cue control unit 18 so that the cue control unit 18 may direct the sound control unit 14 to generate the connection information sound.

### Modified Embodiments

In the following, modified embodiments of the information communication system according to the present invention are described.

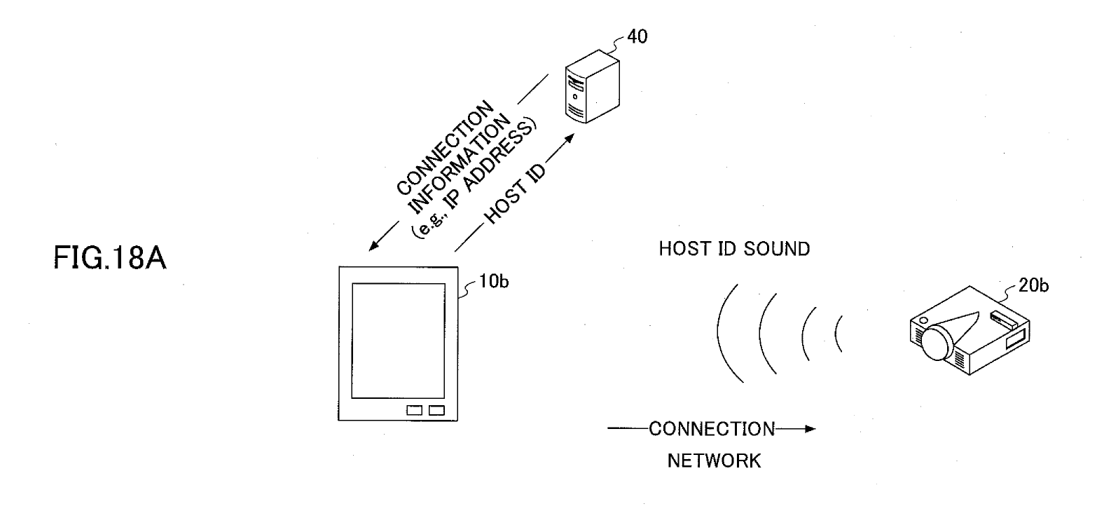

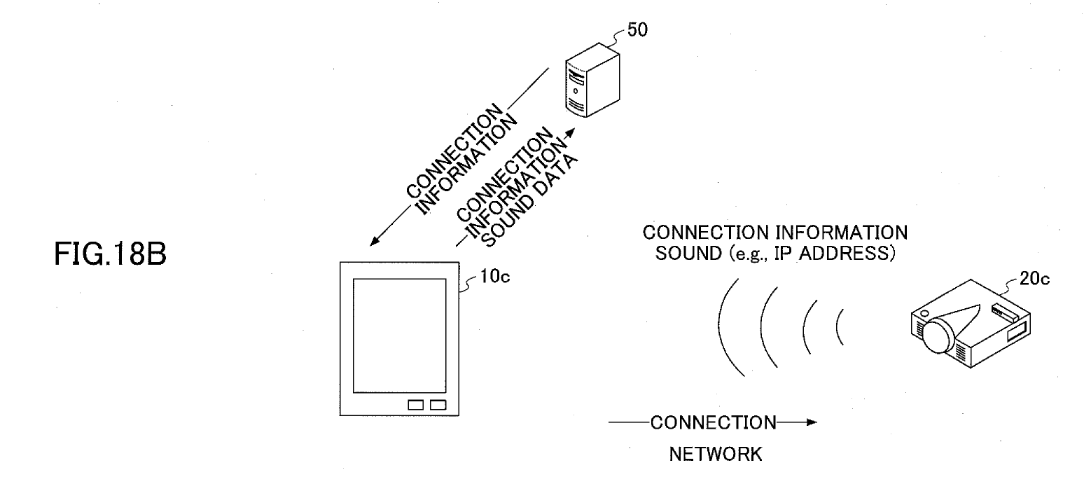

FIG. 18A is a diagram illustrating a first modified embodiment in which the information communication system includes a connection information converting unit 40 in addition to a client apparatus 10b and a host apparatus 20b.

It is noted that in the first and second embodiments of the present invention, the client apparatus 10 or 10a obtains the connection information such as an IP address included in the connection information sound output by the host apparatus 20 or 20a.

In the present modified embodiment, the connection information converting unit 40 stores identification information that is unique to the host apparatus 20b (host ID) in association with connection information for establishing connection with the host apparatus 20b. The host ID unique to the host apparatus 20b may be a two-digit number or any other type of code for unambiguously identifying the host apparatus 20b.

In FIG. 18A, when the host apparatus 20b outputs an identification information sound (host ID sound) having the host ID unique to the host apparatus 20b embedded therein, the client apparatus 10b obtains the host ID sound via a sound gathering unit such as a microphone and has the sound analyzing unit 15 analyze the host ID sound to obtain the host ID unique to the host apparatus 20b.

The client apparatus 10b has the communication unit 13 transmit the obtained host ID to the connection information converting unit 40 via a wireless or wired network and receive the connection information associated with the host ID from the connection information converting unit 40. Then, the client apparatus 10b has the communication unit 13 establish connection with the host apparatus 20b via a network using the connection information received from the connection information converting unit 40.

In one preferred embodiment, the connection information converting unit 40 may be implemented in a server or a client apparatus other than the client apparatus 10b or the host apparatus 20b. For example, the connection information converting unit 40 may be implemented in a cloud server.

According to an aspect of the present embodiment, by having the host apparatus 20b output a host ID with a smaller amount of information than connection information such as an IP address, the sound analyzing time of the client apparatus 10b may be reduced and the sound analyzing accuracy of the client apparatus 10b may be improved, for example.

FIG. 18B is a diagram illustrating a second modified embodiment in which the information communication system includes a sound analyzing unit 50 in addition to a client apparatus 10c and a host apparatus 20c.

It is noted that in the first and second embodiments of the present invention, the client apparatus 10 or 10a has the sound analyzing unit 15 analyze the connection information sound output from the host apparatus 20 or 20a to obtain the connection information for establishing a connection with the host apparatus 20 or 20a.

In the present modified embodiment, the client apparatus 10c has the sound gathering control unit 11 gather a connection information sound output from the host apparatus 20c via a sound gathering unit such as a microphone and convert the gathered sound into connection information sound data. The client apparatus 10c then has the communication unit 13 transmit the connection information sound data to the sound analyzing unit 50 via a wireless or wired network.

The sound analyzing unit 50 has functions similar to the sound analyzing unit 15 of the first and second embodiments. The sound analyzing unit 50 receives the connection information sound data from the client apparatus 10c, analyzes the connection information sound data, and extracts the connection information included in the connection information sound data. Then, the sound analyzing unit 50 transmits the extracted connection information to the client apparatus 10c. The client apparatus 10c has the communication unit 13 receive the connection information of the host apparatus 20c from the sound analyzing unit 50 and use the received connection information to establish a connection with the host apparatus 20c via a network.

In one preferred embodiment, the sound analyzing unit 50 may be implemented in a server or a client apparatus other than the client apparatus 10c or the host apparatus 20c. For example, the sound analyzing unit 50 may be implemented in a cloud server.

According to an aspect of the present embodiment, a connection may be established with a device within a predetermined range using a sound having connection information embedded therein.

Further, the present invention is not limited to these embodiments, and numerous variations and modifications may be made without departing from the scope of the present invention.

The present application is based on and claims the benefit of the priority date of Japanese Patent Application No. 2011-202425 filed on Sep. 15, 2011, with the Japanese Patent Office, the entire contents of which are hereby incorporated by reference.

What is claimed is:

1. An information communication system comprising:
a host apparatus configured to generate and output a connection information sound;
a client apparatus configured to gather the connection information sound output by the host apparatus; and
a sound analyzing unit configured to analyze the connection information sound and obtain connection information from the connection information sound;
wherein the client apparatus includes a communication unit configured to establish communication with the host apparatus based on the connection information obtained by the sound analyzing unit.

2. A client apparatus comprising:
a sound gathering unit configured to gather a connection information sound output by a host apparatus;
a sound analyzing unit configured to analyze the connection information sound gathered by the sound gathering unit and obtain connection information from the connection information sound; and
a communication unit configured to establish communication with the host apparatus based on the connection information obtained by the sound analyzing unit.

3. The client apparatus as claimed in claim 2, further comprising:
a sound generating unit configured to generate a requesting sound for requesting the host apparatus to output the connection information sound.

4. The client apparatus as claimed in claim 3, further comprising:
a sound control unit configured to control at least one of the sound generating unit and the sound analyzing unit;
wherein the sound control unit directs the sound generating unit to generate the requesting sound at a frequency that is different from a frequency of the connection information sound output by the host apparatus.

5. The client apparatus as claimed in claim 4, wherein
the sound control unit controls the connection information sound to be analyzed by the sound analyzing unit according to a distance of the host apparatus.

6. The client apparatus as claimed in claim 4, wherein
the sound control unit determines whether the connection information sound has been output by the host apparatus within a prescribed time period since the requesting sound has been output to the host apparatus; and
the sound control unit directs the sound generating unit to output the requesting sound a prescribed number of times upon determining that the connection information sound has not been output by the host apparatus within the prescribed time period.

7. The client apparatus as claimed in claim 2, wherein
when the sound gathering unit gathers an identification information sound including unique identification information of the host apparatus from the host apparatus, the sound analyzing unit analyzes the identification information sound and obtains the unique identification information; and
the communication unit transmits the unique identification information obtained y the sound analyzing unit to a connection information converting unit that stores the unique identification information in association with the connection information of the host apparatus and obtains the connection information from the connection information converting unit.

8. The client apparatus as claimed in claim 2, wherein
the communication unit is configured to transmit the connection information gathered by the sound gathering unit to the sound analyzing unit, receive the connection information obtained by the sound analyzing unit from the sound analyzing unit, and establish communication with the host apparatus based on the connection information.

9. A host apparatus comprising:
a sound generating unit configured to generate a connection information sound including connection information; and
a sound output control unit configured to output the connection information sound generated by the sound generating unit.

10. The host apparatus as claimed in claim 9, wherein
the connection information includes an IP address.

11. The host apparatus as claimed in claim 9, wherein
the connection information includes information used to establish an ad hoc connection.

12. The host apparatus as claimed in claim 9, further comprising:
a sound control unit configured to control the sound generating unit;
wherein the sound control unit directs the sound generating unit to generate the connection information sound at a frequency within a predetermined high frequency band.

13. The host apparatus as claimed in claim 12, wherein
the sound control unit directs the sound generating unit to adjust a volume of the connection information sound based on a predetermined volume for reaching a predetermined range.

14. The host apparatus as claimed in claim 12, further comprising:
a cue control unit configured to control the output of the connection information sound based on a predetermined cue;
wherein the cue control unit directs the sound control unit to output the connection information sound based on a predetermined sound obtained from a client apparatus.
